(19) United States
(12) Patent Application Publication
(10) Pub. No.: US 2025/0005664 A1
(43) Pub. Date: Jan. 2, 2025

(54) SYSTEMS FOR DISTRIBUTED ORDER PROCESSING

(71) Applicant: Indigo Ag, Inc., Charlestown, MA (US)

(72) Inventors: Ian KOENIGSKNECHT, Somerville, MA (US); Aumit Hasan LEON, Melrose, MA (US); Tze Tsun Justin LEE, Somerville, MA (US); Matthew Donovan GRIISSER, Somerville, MA (US)

(21) Appl. No.: 18/707,540

(22) PCT Filed: Oct. 21, 2022
(86) PCT No.: PCT/US2022/047390

§ 371 Date: May 3, 2024

Related U.S. Application Data
(60) Provisional application No. 63/276,511, filed on Nov. 5, 2021.

(51) Int. Cl. G06Q 40/04; G06Q 20/40

(52) U.S. Cl. CPC G06Q 40/04; G06Q 20/401

(57) ABSTRACT

Systems, methods, and computer program products for distributed order processing are provided. A request for a price quote for a tradable asset is sent to a pricing server. The request includes user metadata including a user identifier and asset metadata including an asset identifier. A price quote with associated price metadata is received from the pricing server based on the asset metadata. A digest is generated from the price, user, and asset metadata and is verifiable with a cryptographic key. The price, user, and asset metadata are combined with the digest, thereby generating a verifiable transaction initiation object. The initiation object is provided to a user for provision to a transaction server for execution. A request to authenticate the initiation object is received from the transaction server. An approval to execute the initiation object is sent to the transaction server without reference to the pricing server.

### CROSS-REFERENCE TO RELATED APPLICATIONS

This application claims the benefit of U.S. Provisional Application No. 63/276,511, filed Nov. 5, 2021, which is hereby incorporated by reference in its entirety.

### BACKGROUND

The present disclosure relates to generating verifiable transaction initiation objects for locking-in real-time tradable asset (e.g., a commodity futures contract) price quotes to thereby complete contract purchases in an efficient distributed manner. Futures contracts generally require some time from quote to execution of a transaction due to a number of processing and/or validation steps that occur to execute the transaction. When futures prices are quoted to bidders, specific prices of futures contract(s) may change over the course of mere seconds, resulting in a bidder to receive a different price from the quoted price when the transaction ultimately executes.

Accordingly, there exists a need for a process that allows a bidder of a tradable asset to lock-in a quote price for later execution, allows for cryptographically validation of a proposed transaction against a stored copy of the quote data, and allows for futures contract transaction execution without repeated calls to a quote server for quote data.

### BRIEF SUMMARY

In various embodiments, a method of distributed order processing includes is provided where a request for a price quote for a tradable asset is sent to a pricing server. The request includes user metadata including a user identifier and asset metadata including an asset identifier. A price quote is received from the pricing server based on the asset metadata. The price quote includes price metadata including a price and a price timestamp. A digest is generated from the price metadata, user metadata, and asset metadata. The digest is verifiable with a cryptographic key. The price metadata, user metadata, and asset metadata are combined with the digest, thereby generating a verifiable transaction initiation object. The verifiable transaction initiation object is provided to a user for provision to a transaction server for execution. A request to authenticate the verifiable transaction initiation object is received from the transaction server. An approval to execute the verifiable transaction initiation object is sent to the transaction server without reference to the pricing server.

In various embodiments, a system for distributed order processing includes is provided. The system includes a first computing node, a second computing node, and a third computing node. The first computing node is configured to perform a method where a request for a price quote for a tradeable asset is sent to a second computing node. The request includes user metadata including a user identifier and asset metadata including an asset identifier. A price quote is from the second computing node based on the asset metadata. The price quote includes price metadata having a price and a price timestamp. A digest is generated from the price metadata, user metadata, and asset metadata. The digest is verifiable with a cryptographic key. The price metadata, user metadata, and asset metadata are combined with the digest, thereby generating a verifiable transaction initiation object. The verifiable transaction initiation object is provided to a user for provision to a third computing node for execution. A request to authenticate the verifiable transaction initiation object is received from the third computing node. An approval to execute the verifiable transaction initiation object is sent to the third computing node without reference to the second computing node. The second computing node is configured to perform a method where the request for the price quote for a tradable asset is received from the first computing node. The price quote is generated. The price quote including price metadata having a price and a price timestamp is sent to the first computing node. The third computing node is configured to perform a method where the verifiable transaction initiation object is received from the user. The first computing node is sent a request to authenticate the verifiable transaction initiation object. An approval to execute the verifiable transaction initiation object is received from the first computing node. The verifiable transaction initiation object is executed without reference to the second computing node.

In various embodiments, a computer program product for distributed order processing is provided. The computer program product includes a computer readable storage medium having program instructions embodied therewith. The program instructions are executable by a processor to cause the processor to perform a method where a request for a price quote for a tradable asset is sent to a pricing server. The request includes user metadata including a user identifier and asset metadata including an asset identifier. A price quote is received from the pricing server based on the asset metadata. The price quote includes price metadata including a price and a price timestamp. A digest is generated from the price metadata, user metadata, and asset metadata. The digest is verifiable with a cryptographic key. The price metadata, user metadata, and asset metadata are combined with the digest, thereby generating a verifiable transaction initiation object. The verifiable transaction initiation object is provided to a user for provision to a transaction server for execution. A request to authenticate the verifiable transaction initiation object is received from the transaction server. An approval to execute the verifiable transaction initiation object is sent to the transaction server without reference to the pricing server.

### BRIEF DESCRIPTION OF THE SEVERAL VIEWS OF THE DRAWINGS

FIG. 1 is a system diagram for distributed order processing according to embodiments of the present disclosure.

FIGS. 2A-2H is a flowchart illustrating distributed order processing according to embodiments of the present disclosure.

FIG. 3 depicts a computing node according to an embodiment of the present disclosure.

### DETAILED DESCRIPTION

In various embodiments, systems, methods, and computer program products are provided for distributed order processing leveraging a verifiable transaction initiation object.

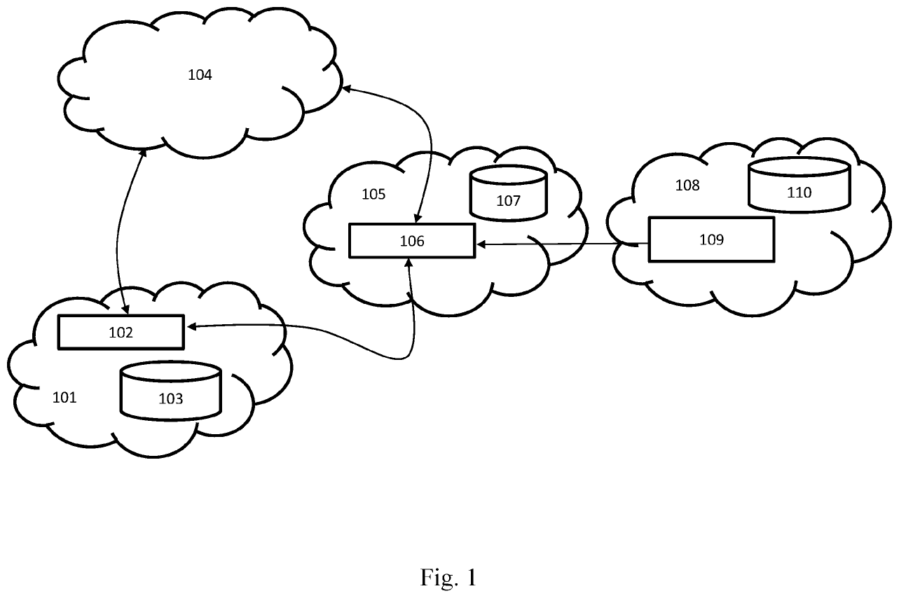

FIG. 1 illustrates a system for distributed order processing for a tradable asset. As shown in FIG. 1, the system 100 includes a transaction node 101 having a transaction application programming interface (API) 102 and a transaction database 103, a user interface (UI) 104, a bid node 105 having a bid API 106 and a bid database 107, and a futures pricing node 108 having a futures pricing API 109 and a futures pricing database 110. In various embodiments, the transaction API 102 communicates with the bid API 106. In various embodiments, the transaction API 102 communicates with the user interface 104. For example, a user may provide a bid to the bid API 106 via the user interface 104 and the bid may be stored in the bid database 107. In another example, the user may receive transaction data from the transaction database 103 by submitting a request to the transaction API 102 via the user interface 104.

In various embodiments, a quote for a tradable asset (e.g., a commodity futures contract) is generated prior to order execution. In such embodiments, the buy-side basis pricing order that the futures price is quoted against is computed based on various live data, including transport and storage costs. In various embodiments, the quote is generated for a given party, which may have an associated supply profile. In various embodiments, this supply profile is read as part of the quoting process. In various embodiments, the buy side basis pricing order and/or the supply profile is sent/received via an API (e.g., REST) request.

In various embodiments, the system may determine a basis order. In various embodiments, the system generates order metadata. In various embodiments, the order metadata includes a commodity identifier, a futures symbol (e.g., CZ1), a country code (e.g., US), a quantity of contracts, and/or product information. In various embodiments, given the symbol and country code, the system requests the latest trade price for the symbol on the order's pricing record.

In various embodiments, the system validates that the asset (e.g., a commodity future) is tradable. For example, the system may determine that the commodity is trading at a tradable price (e.g., by confirming that there is no more than one price given). In various embodiments, the system validates the information on the futures price response against the order. In various embodiments, the system generates a data object, for example, a JavaScript Object Notation (JSON), containing the futures price information. In various embodiments, the data object includes a profile ID for which the quote was generated. In various embodiments, the data object includes product information. In various embodiments, the data object includes an expiry date and/or time. In various embodiments, the date-time is in a predetermined format, such as the ISO-8601 format that is a predetermined amount of time (e.g., exactly 60 seconds) in the future. In various embodiments, the date-time is generated at the very end of the request to ensure minimal time is consumed by any requests (e.g., a HTTP request).

In various embodiments, the data object is used to generate a verifiable transaction initiation object. In various embodiments, the verifiable transaction initiation object may be a token, such as a JSON Web Token (JWT).

In various embodiments, a digest is generated based on the data contained in the data object. In various embodiments, the digest is generated based on at least a portion (e.g., all) of the data from the data object. In various embodiments, a digest is generated based on the data contained in the data object, which is then encrypted. In various embodiments, the encoding is a binary-to-text encoding scheme. In various embodiments, the binary-to-text encoding scheme is Base64. In various embodiments, the encoded data object is cryptographically-signed. In various embodiments, the verifiable transaction initiation object is generated including the original data contained in the data object with the encoded (and, optionally, encrypted) representation of the data within the data object.

In various embodiments, the verifiable transaction initiation object is signed by the system. In various embodiments, the verifiable transaction initiation object is generated by a token generator (e.g., a backend server process) using a cryptographic secret (e.g., a shared secret or a key pair) that only the token generator can access. In various embodiments, the verifiable transaction initiation object includes the digest in addition to the data from the data object. In various embodiments, the digest is generated based on at least a portion (e.g., all) of the data from the data object and the cryptographic secret. In various embodiments, the cryptographic secret is stored locally at the backend server. In various embodiments, the cryptographic secret is stored at a remote (e.g., cloud) server. In various embodiments, the remote server authenticates users such that only the generator of the verifiable transaction initiation object can access the cryptographic secret used to generate the verifiable transaction initiation object. In various embodiments, data contained within the data object is transferred (e.g., copied) to the token without encryption such that any system can read the data from the data object that is contained within the verifiable transaction initiation object. In various embodiments, only the system with access to the cryptographic secret (e.g., the token generator) is able to verify the verifiable transaction initiation object as authentic by decrypting the digest using the cryptographic secret (and decoding the digest, if the data was previously encoded).

In various embodiments, the verifiable transaction initiation object is returned to the client (with the data from the data object and the digest). In various embodiments, the verifiable transaction initiation object is combined with raw information contained within the verifiable transaction initiation object so that the receiving client doesn't need to read the JWT directly.

In various embodiments, the data contained in the data object is hashed with a hash function to thereby generate a hash of the data contained in the data object. In various embodiments, the resulting hash may be encrypted to thereby provide protection against manipulation of the data. In various embodiments, when the verifiable transaction initiation object is verified, the data contained within the verifiable transaction initiation object (excluding the hash) can be hashed at a server (e.g., by the bid server) using the universal hash function and the resulting hash can be compared with the hash (after decryption, if the hash is encrypted) provided in the verifiable transaction initiation object. In various embodiments, the token generator may access the appropriate universal hash function. In various embodiments, the token generator may provide the universal hash function to any processes or servers that would require the universal hash function to verify the authenticity of the verifiable transaction initiation object.

In various embodiments, at least a portion (e.g., all) of the data contained within the verifiable transaction initiation object is encrypted using a suitable cryptographic methods (e.g., AES, RSA, etc.) such that the data must be decrypted to be read. In various embodiments, the digest may be the only encrypted portion of the verifiable transaction initiation object. In various embodiments, symmetrical encryption is used. In various embodiments, asymmetrical encryption is used. For example, an asymmetrical encryption method is used to encrypt all data contained within the verifiable transaction initiation object such that only the token generator may decrypt the verifiable transaction initiation object and read the data.

In various embodiments, the system records the generated token and its related metadata in a database table for audit purposes.

In various embodiments, the bid API 106 generates data including at least one of the following fields: a unique user ID; a unique bid ID; a generated JWT; a token expiration timestamp; a created-at date; a created-by user ID; a deleted-at date; and/or a deleted-by user ID.

In various embodiments, the token includes: a generated JWT body (the “unpacked” token); futures price metadata; a quantity of futures; a currency code; a price retrieval timestamp; and/or a crop code.

In various embodiments, the system ingests futures prices from a price quoting service. In various embodiments, the price quoting service provides prices over a constant web socket connection. In various embodiments, the provided prices include at least one of: trade prices; bid prices; and/or ask prices. In various embodiments, trade prices refer to concrete transactions that were recorded on an exchange (e.g., a client bought corn with futures month Z2021 at a price of $5.67). In various embodiments, trade prices are the most accurate determiner of what price a grower may receive for their product, because a real trade has been executed at that trade price. In various embodiments, bid prices refer to prices that buyers have posted on the exchange as the maximum price they would be willing to pay for a commodity with a given reference month (e.g., a buyer would be willing to buy corn with futures month Z2021 at a price of $5.67). In various embodiments, the bid price may be more frequently updated than trade prices, particularly for months further in the future. In various embodiments, ask prices refer to prices that sellers have posted on the exchange as the minimum price they would be willing to accept for the commodity they own with a given reference month (e.g., a seller would be willing to sell corn with futures month Z2021 at a price of $5.67).

In various embodiments, the system determines tradability metric of futures prices returned by the pricing server (e.g., via an API). In various embodiments, the tradability metric may be a function of how recently a trade has occurred. For example, if a particular commodity with a particular reference month has been traded in a predetermined prior period of time (e.g., the last 30 seconds), that commodity is considered tradable (i.e., can be transacted on the exchange) for that futures reference month. In various embodiments, the tradability metric includes a past trade cutoff time of about 1 second to about an hour. In various embodiments, the tradability metric includes a past trade cutoff time of about 10 seconds to about 10 minutes. In various embodiments, the tradability metric includes a past trade cutoff time of about 30 seconds. In various embodiments, tradability is used as a representation of the market hours of the exchange. In various embodiments, tradability is used to generate a quote token for a given commodity-month combination. In various embodiments, a non-tradable asset (e.g., commodity futures) is not be able to be actioned upon at the exchange by a buyer and thus will not be transacted on as cash.

In various embodiments, the system processes (e.g., set) basis and futures separately. In various embodiments, each process is a distinct operation performed at distinct points in time. In various embodiments, for basis as cash, processing of basis and futures are performed in succession. In various embodiments, for basis as cash, setting of basis and futures may be performed within minimal time in between steps. In various embodiments, basis setting and futures setting operations are performed within milliseconds of each other.

In various embodiments, when a user receives a valid quote token from a token generator (e.g., bid node) and/or passes user interface (UI) validations, the quote token is passed into an initial request to transact on the order. In various embodiments, the system determines a material transfer agreement (MTA) by which the order(s) will be directed. In various embodiments, they system performs validations of an order. In various embodiments, to perform validations, the relevant order(s) is read from the database given the ID(s) on the instruction(s). In various embodiments, validations are performed against the order(s) found. In various embodiments, these validations include, but are not limited to, validating status of the order(s) (i.e., determining whether a given order in a state that can be transacted on), determining whether all order instructions result in a found order, determining whether all orders found have matching metadata (e.g., a corn order and another corn order), etc. In various embodiments, when a token is present, the metadata in the token body is validated against the order(s) found. In various embodiments, validating the metadata in the token include validating that the order ID on the token matches one of the order(s) found, validating that pricing metadata (e.g., futures month and year) matches on both, validating that the product matches, etc.

In various embodiments, the system validates the contents of the quote JWT to determine that: 1. the basis order that the quote was generated against is present on the MTA agreement; 2. the supply profile ID for which the quote was generated is present as a participant on the MTA agreement; 3. the metadata on the token (e.g., product info, country code, etc.) matches what is on the MTA agreement; and/or 4. the JWT has not expired. In various embodiments, if any of the validations fail, the system rejects the agreement in the quote phase. In various embodiments, the system validates the verifiable transaction initiation object by decrypting the digest within the verifiable transaction initiation object. In various embodiments, if the decrypted digest is a hash, the system applies a hash function to at least a portion (e.g., all) of other data within the verifiable transaction initiation object to determine a new hash. In various embodiments, this new hash is compared to the decrypted hash to determine whether the data within the verifiable transaction initiation object is authentic. In various embodiments, if the decrypted digest is encoded data, the system applies a decoding scheme (e.g., Base64) to thereby return the original data contained within the body of the data object. In various embodiments, the resulting decoded data may be compared to a reference stored at the bid server and/or may be compared to the data within the verifiable transaction initiation object itself to determine authenticity of the verifiable transaction initiation object.

In various embodiments, the system performs validations on the futures setting portion of the MTA agreement. In various embodiments, the system validates that a futures price on auto-generated futures orders (whose instructions were just executed) matches what is in the JWT. In various embodiments, this validation provides security that a price was not manipulated (e.g., spoofed by fake orders to manipulate the price up or down) and that, not only does the metadata about the price match (e.g., symbol being quoted matches) but the numerical value of the price also matches. In various embodiments, once the verifiable transaction initiation object is validated as authentic (i.e., known to have originated from the token generating process) and, as of a previous validation, not expired, validations are performed that the futures price set on the agreement matches the price given on the verifiable transaction initiation object. In various embodiments, this validation involves comparing amount, currency, futures month, futures year, and/or trading code (e.g., C); the last three can also be validated by generating the futures symbol (as that is a combination of month, year and code) and comparing the symbols between futures order on the agreement and the verifiable transaction initiation object.

In various embodiments, the system performs validations on the basis setting portion of the MTA agreement. In various embodiments, during basis setting, if any validations fail, the system rejects the agreement in the quote phase. In various embodiments, validations of basis setting ensures that both the futures agreement and the basis agreement are correct.

In various embodiments, generating a quote includes: 1. fetching and validating the basis pricing metadata associated with the bid for which the system is quoting; 2. fetching and validating the futures price for the crop code, month and year combo that matches the bid; 3. generating a token (e.g., JSON) containing all required metadata for the quote; 4. signing the token (e.g., JSON body) and generating an encoded token (e.g., base64 JWT); and/or 5. storing the quote to a quote database so that the decrypted token may be validated at a later time against the stored quote.

In various embodiments, fetching and validating of bid pricing is performed. In various embodiments, to validate that the bid and its pricing are usable, the system first fetches the bid and its related pricing and validates that: 1. the bid is not in a closed or expired state (i.e., the bid is considered tradable/transactable); and 2. the bid has valid basis pricing and has a symbol that is tradable on the futures market.

In various embodiments, fetching and validating of futures pricing is performed. In various embodiments, after bid pricing has been fetched and validated, a current futures price for the particular crop code is determined for a specified month and year combination on the basis pricing of the bid, if available. In various embodiments, tradability is determined from recent pricing. In various embodiments, for a price to be tradable, the specified price must have been traded within a predetermined amount of time prior to the bid (e.g., the last 30 seconds). For example, if a futures price is determined to not be tradable (e.g., last transaction occurred more than an hour ago) or not be a valid futures price (e.g., deviates from recent values significantly), the system throws an error to the user indicating that the futures price is not tradable or is not a valid futures price.

In various embodiments, a token is generated using the methods described above representing the metadata from the bid, the futures price, and the request input. In various embodiments, the token includes a token generation timestamp representing when the token was generated. In various embodiments, the token is in a JSON format. In various embodiments, the token includes an expiry time of the quote. In various embodiments, the token may include a timestamp of the quote. In various embodiments, the token includes a user identifier for which the quote was generated. In various embodiments, the token includes a bid identifier. In various embodiments, the token includes futures price metadata (e.g., a price, a precision, a currency code). In various embodiments, the token includes a futures month and/or year. In various embodiments, the token includes a commodity identifier (e.g., a product name and/or a crop code). In various embodiments, the token includes a country code. In various embodiments, the token includes a timestamp representing the time at which the futures price was retrieved. In various embodiments, as described in more detail above, the data contained within the verifiable transaction initiation object is encoded (e.g., using Base64). In various embodiments, the encoded representation of the data is encrypted into a digest that is contained within the verifiable transaction initiation object in addition to the original data from the body of the data object. In various embodiments, the original data contained within the verifiable transaction initiation object (e.g., the user identifier, the expiry time, the futures price, etc.) is not encrypted and may be read by any system having access to the verifiable transaction initiation object (i.e., the digest is the only encrypted portion of the verifiable transaction initiation object and may be decrypted by a system having access to the appropriate cryptographic key).

In various embodiments, the token is digitally-signed with a cryptographic signature. In various embodiments, a new, signed token is generated. In particular, any of variety of digital signature methods know in the art may be employed. For example, a certificate may be issued by a certificate authority to a bid node as discussed herein. That bid node may then generate a digital signature for the token, which allows verification the authenticity and integrity of the token by a receiver.

In various embodiments, the original, unsigned token is stored in a token database so that the decrypted token may later be validated against the information contained in the token database. In various embodiments, when the bidder proceeds to execute the transaction, the bidder's client transmits the cryptographically signed token to the transaction server, the transaction server decrypts the digest contained in the token and compare the decrypted digest to the original token data stored in the token database. In various embodiments, the transaction server may request that the bid server decrypt the digest contained in the verifiable transaction initiation object (e.g., the transaction server may send the verifiable transaction initiation object to the bid server for processing and verification). In various embodiments, the decrypted (and/or decoded) digest data may be compared to the original data contained within the verifiable transaction initiation object to determine whether the original data was altered or compared to a reference stored at a backend server (e.g., the bid server). In various embodiments, when the data in the token matches the original token data stored in the token database, the transaction may execute at the price quoted in the token. In various embodiments, when the data in the token does not match the original token data stored in the token database, the transaction may be cancelled. In various embodiments, the bidder may be notified of a cancelled transaction and/or the reason for the cancelled transaction (e.g., mismatch of token data generally, mismatch of specific token data, etc.). In various embodiments, the disclosed order verification system is advantageous in distributed trading systems because the system does not need to make additional requests (e.g., more than one) to a pricing server to obtain a price quote for a tradable asset (e.g., a commodity futures contract).

In various embodiments, a single entity may perform both creating and validating quotes during a transaction. In various embodiments, one entity may perform creating a quote while another entity performs validating quotes. In various embodiments, inflating and validating bids for transaction includes the following steps: 1. unpacking the signed JWT into a JSON payload; 2. validating that the transacting seller matches the seller on the quote; 3. validating that the bid matches the bid on the quote; 4a. validating that the futures pricing on the transaction matches the futures pricing on the quote; 4b. attaching the futures pricing to the output for use on the transaction; and/or 5. validating that the quote has not expired. In various embodiments, inflating the bid allows for a minimum amount of information to be required (e.g., just the bid ID) to determine the details of a transaction.

In various embodiments, unpacking the signed token (e.g., a base64-encoded JWT) includes decrypting and/or decoding the digest contained within the token to thereby obtain the original data payload within the unsigned token (e.g., data within the JSON body).

In various embodiments, validating the bid includes comparing the bid identifier between the decrypted (and/or decoded) digest within the token and the data within the stored, original token. In various embodiments, validating the bid includes comparing the bid identifier between the decrypted (and/or decoded) digest within the token and the bid identifier contained within the token itself. In various embodiments, where the digest is a hash, validating the bid includes applying the universal hash function to the data contained within the token, generating a new hash, and determining whether the new hash matches the hash (decrypted has, if the hash was previously encrypted) provided in the token. In various embodiments, validating the bid includes comparing the user identifier.

In various embodiments, validating the futures pricing includes comparing the quoted price in the decrypted (and/or decoded) verifiable token to the quote price in the data within the stored, original token. In various embodiments, validating the futures pricing includes comparing the quoted price in the decrypted (and/or decoded) digest to the quote price in the data contained within the token itself. In various embodiments, where the digest is a hash, validating the futures pricing includes applying the universal hash function to the data contained within the token, generating a new hash, and determining whether the new hash matches the hash (decrypted has, if the hash was previously encrypted) provided in the token. In various embodiments, the system transforms any quote so that the quote numbers may be compared. For example, quotes may be converted to integers, quote may be adjusted to have the same precision, and/or quote styles (e.g., currency, etc.) may be adjusted.

In various embodiments, after validation of the quoted futures price, the validated price is attached to bid output. In various embodiments, after the user submits the bid for validation, the validated price is attached to the bid and the bid may be transmitted to the transaction server for execution.

In various embodiments, an expiry of the token is validated. In various embodiments, the system validates that the decrypted token has not expired prior to allowing the transaction to execute. In various embodiments, expiry validation is performed as late in the validation process as possible to prevent a bid from executing past its expiry due to, for example, long API and/or database calls.

### Exemplary User Flow:

In various embodiments, available bids are displayed to a seller and the available bid data may be aggregated with real-time futures prices. In various embodiments, a bidder is provided the option to purchase grain at a cash price that is the combination of basis, futures and transport costs. In various embodiments, a request is sent to the API to lock-in the quoted futures price. In various embodiments, to lock in this price, the system requires the following information: the bid for which a quote is being generated; and the seller for which the quote is being generated.

In various embodiments, given the above information, the system determines the latest real-time futures price for the futures month and year and futures symbol included in the bid being quoted against. In various embodiments, the bid is validated as being usable for generating a quote, the pricing on the bid is validated as basis pricing, the futures symbol is validated as a usable futures symbol (e.g., CZ1) configured to be mapped to a futures price, the bid is validated as not expired or closed, the futures price is validated before quoting, and/or the bid price is validated as tradable in that the last trade price was recent enough to be considered usable. In various embodiments, a new timestamp is generated. In various embodiments, metadata is compiled on the seller, original did, futures pricing, product (i.e., grain) to be sold, and/or timestamps for futures price retrieval from source and quote generation. In various embodiments, the collected metadata is packaged (e.g., in the body of a JSON object), encoded (e.g., using Base64) in a JWT, and/or signed cryptographically. In various embodiments, the original, packaged data (i.e., the JSON data object) and/or the signed token may be stored in a database.

In various embodiments, the signed token is returned with an expiration timestamp and futures price metadata to the UI for use and display purposes to a user. In various embodiments, the user is given the option to accept the quoted cash price (i.e., basis+futures+transport costs) within the allotted timeframe or not. In various embodiments, if the user accepts the quote, the bid is executed as a transaction.

In various embodiments, additional validations occur at the transaction side. In various embodiments, when generating the transaction, the system validates that the information in the intended transaction matches the quote. In various embodiments, validation is performed that the seller the quote was generated for is the sell-side participant in the transaction. In various embodiments, the bid being used in the transaction is validated as the same bid for which the quote was generated. In various embodiments, the quote is validated as having not expired as of the time of generating the transaction. In various embodiments, the pricing expressed in the intended transaction is validated as matching the pricing in the quote. In various embodiments, the commodity identifier in the transaction is validated against the commodity identifier in the quote.

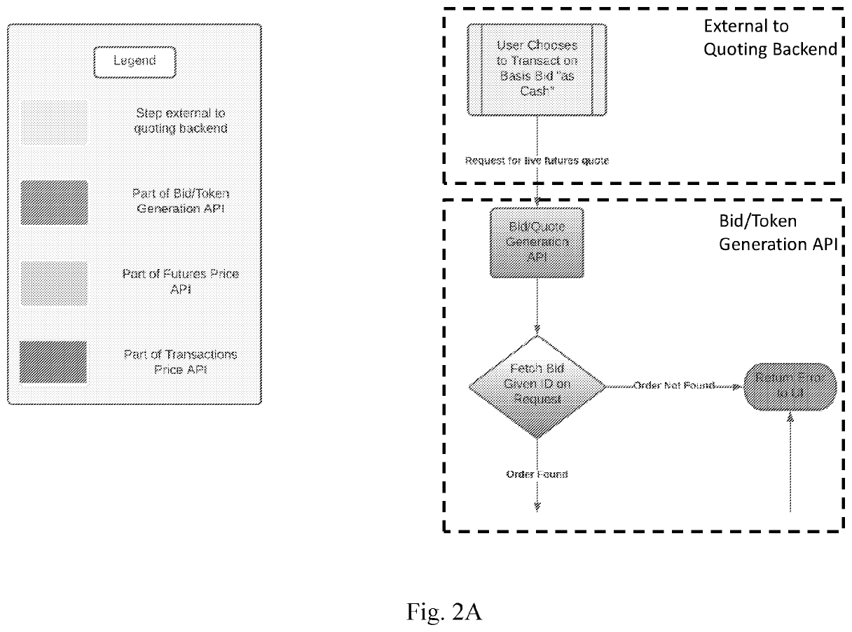

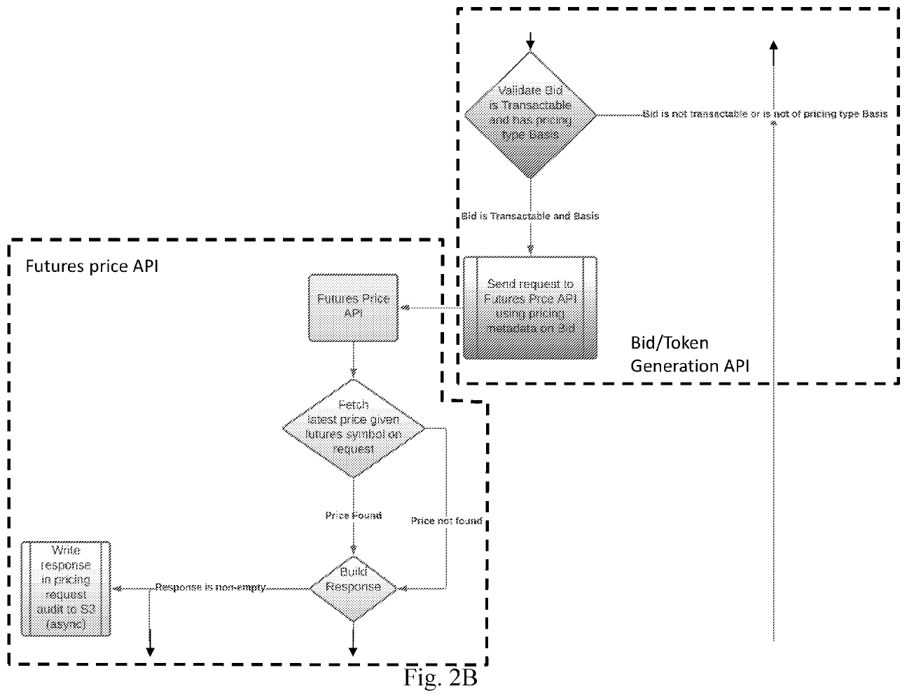

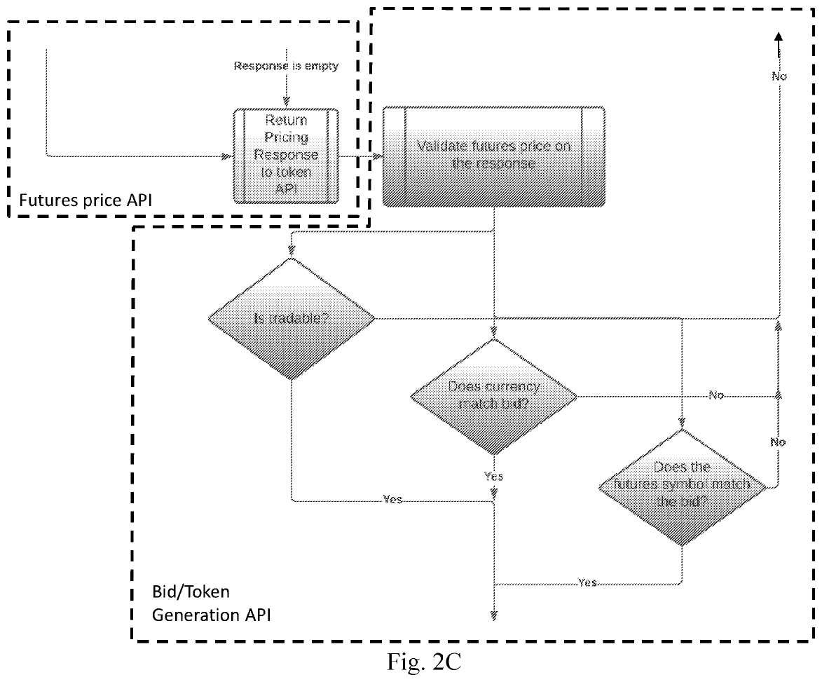

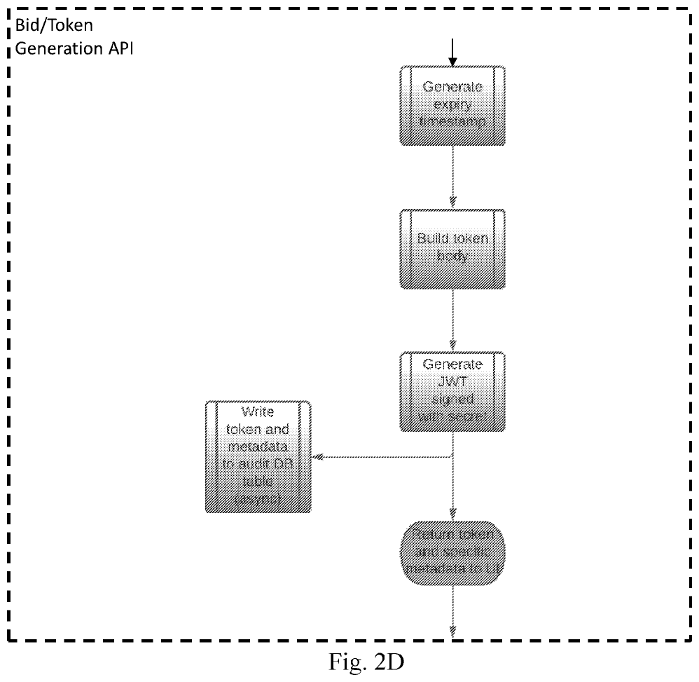

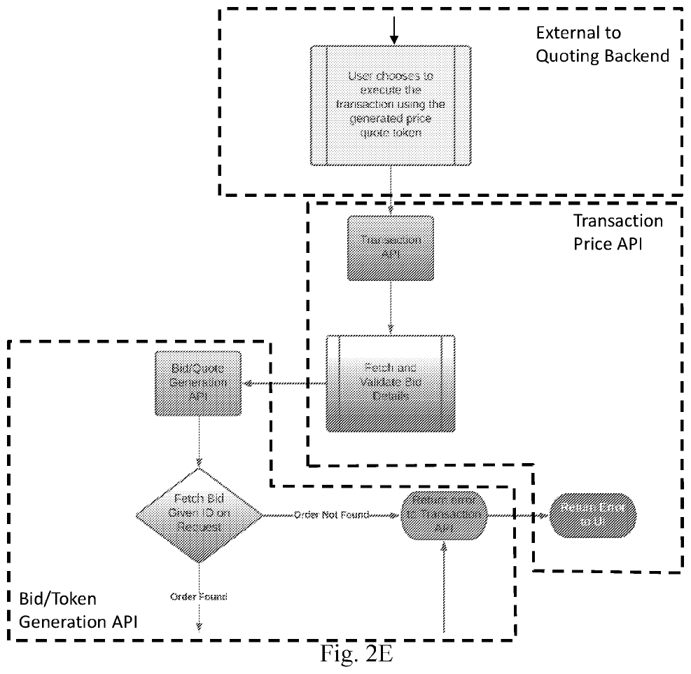

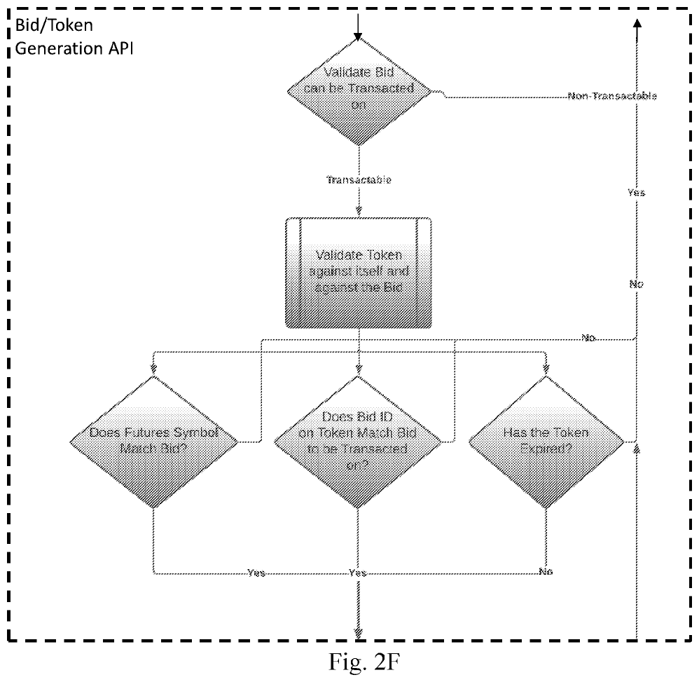

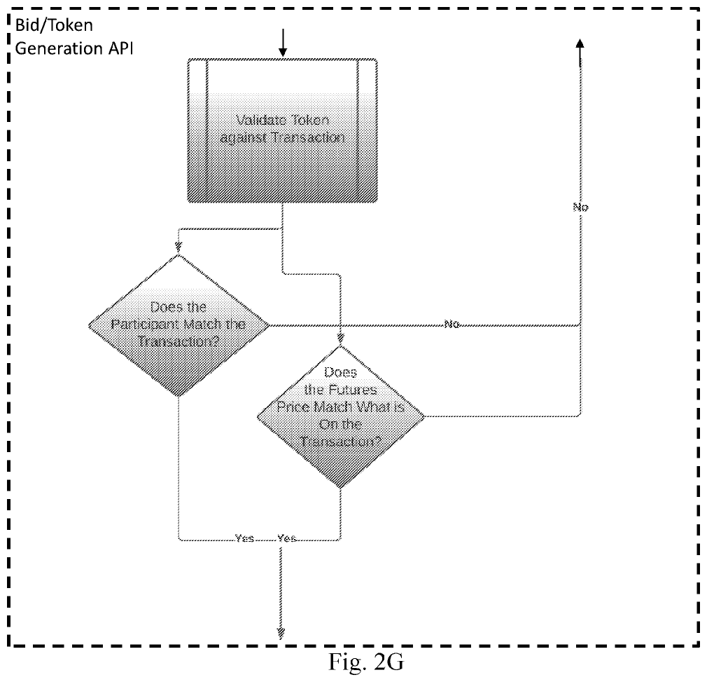

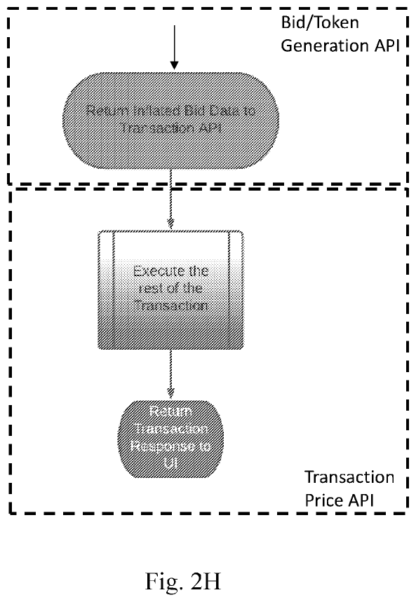

FIGS. 2A-2H is a flowchart illustrating distributed order processing. As shown in FIG. 2A, a user chooses to transact on a basis bid as cash and requests a live futures quote from the bid/quote generation API. The bid/quote generation API fetches the bid given the bid ID on the request. If the order is not found, an error is returned to the user interface. If the order is found, the process proceed to FIG. 2B, where a bid is validated as transactable and has pricing type has a basis. In the bid is not transactable, an error is returned to the user interface. If the bid is transactable and pricing type has a basis, a request is sent to a futures price API using the pricing metadata on the bid. The futures price API fetches the latest price given the futures symbol on the request. A response is built based on whether the price is found or not found. If the response is empty, the process proceed to FIG. 2C where a pricing response is returned to a token API and futures price validations may be performed on the response. If the response is non-empty, the response is written in the pricing request audit to a database (e.g., Amazon S3 database). In various embodiments, this process may be asynchronous. The process proceeds to FIG. 2C where a pricing response is returned to a token API and futures price validations may be performed on the response. When performing validations, the system determines whether the futures price is tradable, whether the currency matches the bid, and whether the futures symbol matches the bid. If any one or more of these validations come back as failed, an error is returned to the user interface. If all of these validations are passed, the process moves to FIG. 2D, where an expiry timestamp is generated. A token, such as a JSON Web Token (JWT), body is built. A token (e.g., a JWT) is generated and signed with a cryptographic secret. The token and metadata is written to an audit database table (may be an asynchronous process). The token and specific metadata are returned to the user interface and the process proceeds to FIG. 2E. After the token (with or without metadata) is received at the user interface, the user chooses to execute the transaction using the generated price quote token. The transaction API then fetches and validates the bid details by sending a request to the bid/quote generation API, which fetches the bid given the bid ID on the request. If the order is not found, an error is returned to the transaction API and an error is returned to the user interface. If the order is found, the process proceeds to FIG. 2F, where the bid is validated as able to be transacted on. If the bid is not transactable, an error is returned to the transaction API and an error is returned to the user interface. If the bid is transactable, the token is validated against itself and against the bid by determining whether the futures symbol matches the bid, whether the bid ID on the token matches the bid to be transacted on, and whether the token has expired (which may be the last validation to occur). If any one or more of these validations come back as failed, an error is returned to the transaction API and an error is returned to the user interface. If all of these validations are passed, the process moves to FIG. 2G, where the token is validated against the transaction by determining whether the participant matches the transaction and whether the futures price matches what is on the transaction. If any one or more of these validations come back as failed, an error is returned to the transaction API and an error is returned to the user interface. If both of these validations are passed, the process moves to FIG. 2H, where inflated bid data is returned to the transaction API. The transaction is then executed at the transaction API and a transaction response is returned to the user interface from the transaction API.

### Definitions

A “marketplace” is a service that allows multiple parties on both the buy and sell side to exchange commodities and services for currency or other commodities or services.

An “order” is an expression of intent to exchange a certain amount of currency, commodities or services for another party's currency, commodities or services on an Indigo Marketplace with an established set of constraints and requirements.

A “buyer” is any party that wishes to exchange their currency, e.g. USD, for another party's commodity, e.g. Soybeans.

A “seller” is any party that wishes to exchange their commodity, e.g. Soybeans, for another party's currency, e.g. USD.

A “side” is either a buy-side or sell-side and denotes the directionality of the order (e.g., do you wish to obtain a commodity/service or exchange your commodity/service for something else). A buyer creates a buy orders, while a seller create a sell order.

“Cash” refers to an order that has a static price paid out in fungible currency with no linkage to a commodity futures market.

“Basis” is a pricing type that sets the price over or under the reference futures price on a given commodity exchange. To complete the pricing both parties must set the final futures reference price between the time of setting basis and the last holding date for the commodity and pricing month.

“Futures” is a pricing type that sets the reference price for a commodity given a pricing month. A futures price fluctuates over time and refers to the current cash price for a given commodity.

“Basis as cash” is a type of transaction that allows an other-side party to transact on a basis-priced order while simultaneously setting the futures reference price to generate a real-time implied cash price for the commodity.

A “quote” is a bundle of data that represents a valid futures reference price and the context in which that price is considered valid and actionable by a marketplace (e.g., data for the usable time window, product identifier, user identifier, etc.).

“Inflating” a bid refers to receiving an identifier for a bid and reading the complete record from the database (along with any other relevant tables that join against or are joined from the primary bid table).

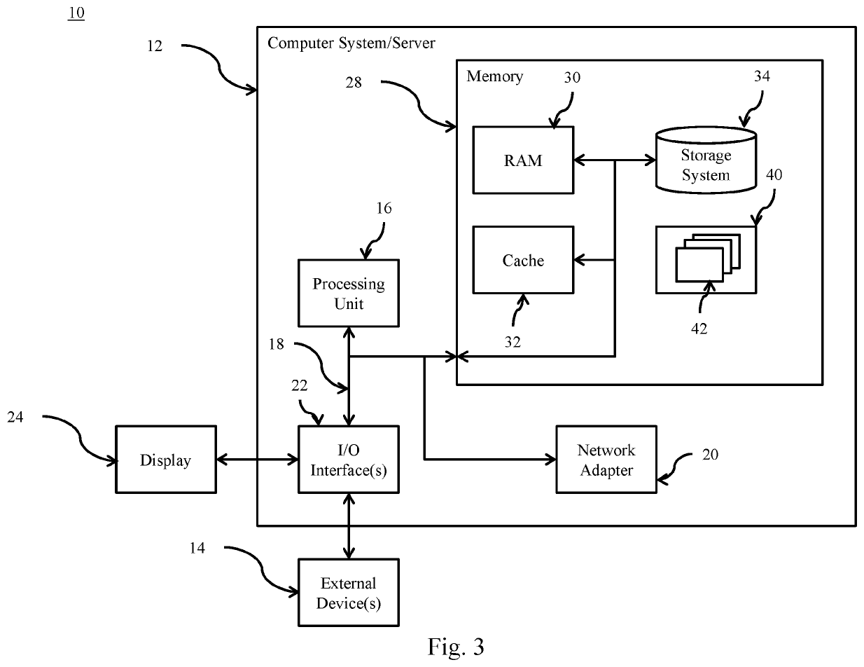

Referring now to FIG. 3, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of distributed order processing, comprising:
sending to a pricing server a request for a price quote for a tradable asset, the request comprising user metadata including a user identifier and asset metadata including an asset identifier;
receiving a price quote from the pricing server based on the asset metadata, the price quote comprising price metadata including a price and a price timestamp;
generating a digest from the price metadata, user metadata, and asset metadata, the digest being verifiable with a cryptographic key;
combining the price metadata, user metadata, and asset metadata with the digest, thereby generating a verifiable transaction initiation object;
providing the verifiable transaction initiation object to a user for provision to a transaction server for execution;
receiving from the transaction server a request to authenticate the verifiable transaction initiation object; and
sending to the transaction server an approval to execute the verifiable transaction initiation object without reference to the pricing server.

2. The method of claim 1, wherein generating the digest comprises:
encoding the price metadata, user metadata, and asset metadata thereby generating an encoded object; and
encrypting the encoded object with the cryptographic key.

3. The method of claim 1, wherein generating a digest comprises:
hashing the price metadata, user metadata, and asset metadata to thereby generate a first hash; and
encrypting the first hash with the cryptographic key.

4. The method of claim 2, wherein the transaction server is configured to:
decrypt and decode the digest; and
execute a transaction for the tradable asset based on the price metadata, user metadata, and asset metadata when the decrypted and decoded digest is validated against a stored reference of the price metadata, user metadata, and asset metadata.

5. The method of claim 3, wherein the transaction server is configured to:
hash the price metadata, user metadata, and asset metadata to obtain a second hash;
compare the first hash to the second hash; and
execute a transaction for the tradable asset based on the price metadata, user metadata, and asset metadata when the first hash matches the second hash.

6. The method of claim 4, wherein execution of the transaction is performed after receipt of the approval to execute.

7. The method of claim 4, wherein the verifiable transaction initiation object further comprises an expiry timestamp, wherein the transaction server is configured to verify the verifiable transaction initiation object by determining whether the request for a price quote is expired based on the expiry timestamp.

8. The method of claim 1, wherein the tradable asset comprises commodity futures, wherein the asset metadata further includes a country identifier, a quantity, a contract month, and a contract year.

9. The method of claim 1, wherein the bid server is configured to determine whether the asset is tradable.

10. The method of claim 1, wherein the transaction server is configured to determine whether the asset is tradable.

11. The method of claim 2, wherein encoding the price metadata, user metadata, and asset metadata comprises a binary-to-text encoding scheme.

12. The method of claim 11, wherein the binary-to-text encoding scheme is base64.

13. The method of claim 4, wherein the request to authenticate the verifiable transaction initiation object includes the decrypted and decoded price metadata, user metadata, and asset metadata, the method further comprising:
storing, at the bid server, the price metadata, user metadata, and asset metadata as the stored reference prior to encoding; and
in response to the request to authenticate, comparing the decrypted and decoded price metadata, user metadata, and asset metadata to the stored reference.

14. A system comprising:
a first computing node, a second computing node, and a third computing node, wherein
the first computing node is configured to perform a method comprising:
sending to a second computing node a request for a price quote for a tradeable asset, the request comprising user metadata including a user identifier and asset metadata including an asset identifier;
receiving a price quote from the second computing node based on the asset metadata, the price quote comprising price metadata including a price and a price timestamp;
generating a digest from the price metadata, user metadata, and asset metadata, the digest being verifiable with a cryptographic key;
combining the price metadata, user metadata, and asset metadata with the digest, thereby generating a verifiable transaction initiation object;
providing the verifiable transaction initiation object to a user for provision to a third computing node for execution;
receiving from the third computing node a request to authenticate the verifiable transaction initiation object; and
sending to the third computing node an approval to execute the verifiable transaction initiation object without reference to the second computing node
the second computing node is configured to perform a method comprising:
receiving from the first computing node the request for the price quote for a tradable asset;
generating the price quote;
sending to the first computing node the price quote comprising price metadata including a price and a price timestamp
the third computing node is configured to perform a method comprising:
receiving the verifiable transaction initiation object from the user;
sending the first computing node a request to authenticate the verifiable transaction initiation object;
receiving from the first computing node an approval to execute the verifiable transaction initiation object; and
executing the verifiable transaction initiation object without reference to the second computing node.

15. A computer program product for distributed order processing, the computer program product comprising a computer readable storage medium having program instructions embodied therewith, the program instructions executable by a processor to cause the processor to perform a method comprising:
sending to a pricing server a request for a price quote for a tradable asset, the request comprising user metadata including a user identifier and asset metadata including an asset identifier;
receiving a price quote from the pricing server based on the asset metadata, the price quote comprising price metadata including a price and a price timestamp;
generating a digest from the price metadata, user metadata, and asset metadata, the digest being verifiable with a cryptographic key combining the price metadata, user metadata, and asset metadata with the digest, thereby generating a verifiable transaction initiation object;
providing the verifiable transaction initiation object to a user for provision to a transaction server for execution;
receiving from the transaction server a request to authenticate the verifiable transaction initiation object; and
sending to the transaction server an approval to execute the verifiable transaction initiation object without reference to the pricing server.

16. (canceled)

17. (canceled)
